(19) United States
(12) Patent Application Publication
(10) Pub. No.: US 2022/0268800 A1
(43) Pub. Date: Aug. 25, 2022

(54) HYBRID SENSOR ASSEMBLY FOR USE WITH ACTIVE NOISE CANCELLATION

(71) Applicant: Molex, LLC, Lisle, IL (US)

(72) Inventors: Kurt DEKOSKI, Macomb Township, MI (US); David DUNHAM, Metamora, MI (US)

(73) Assignee: Molex, LLC, Lisle, IL (US)

(21) Appl. No.: 17/630,923

(22) PCT Filed: Sep. 24, 2020
(86) PCT No.: PCT/US2020/052343

§ 371 Date: Jan. 28, 2022

Related U.S. Application Data
(60) Provisional application No. 62/906,649, filed on Sep. 26, 2019.

(51) Int. Cl. G01P 1/02; G01P 15/00; B60R 13/08; H04R 1/04; H04R 1/08; H04R 3/00

(52) U.S. Cl. CPC G01P 1/023; G01P 15/00; B60R 13/0861; H04R 1/04; H04R 1/086; H04R 3/00; H04R 2499/13

(57) ABSTRACT

A hybrid sensor assembly is configured to be mounted on a vehicle to sense structure borne and airborne noises generated as the vehicle travels over the roads. The sensor assembly includes a housing having a circuit board mounted therein, an accelerometer mounted on the circuit board, a microphone mounted on the circuit board, an acoustic port through the housing and in communication with the microphone, and an acoustic fabric attached to the housing over the port. An acoustic shield covers the acoustic port and substantially deters the entry of fluid and debris into the acoustic port.

### RELATED APPLICATIONS

This application claims priority to U.S. Provisional Application No. 62/906,649, filed Sep. 26, 2019, which is incorporated herein by reference.

### FIELD OF THE DISCLOSURE

The current disclosure generally relates to sensors, such as microphones and accelerometers used in a vehicle for noise cancellation.

### DESCRIPTION OF RELATED ART

Active noise cancellation systems provided in the automotive environment use captured inputs from structure borne and airborne noises, especially regarding road noise. Structure borne road noises can be due to vibrations entering a vehicle based upon the different road surfaces that are traveled over. Airborne noises are created from the tire harmonics generated by different air pressure, tread style, material, or tire size. Active noise cancellation predicts the harmonics that are generated, and this prediction is used in an algorithm to output a noise through the speaker system of your car to focus and cancel that noise.

Currently, separate sensor assemblies are designed dependent upon the sense unit used for the structure borne or airborne noises. Structure borne noise is captured by using an accelerometer sense unit on the exterior of the vehicle, and airborne noise is captured by using a microphone sense element located within the passenger compartment.

To better understand the above-described objectives, characteristics and advantages of the present disclosure, embodiments, with reference to the drawings, are provided for detailed explanations.

### BRIEF SUMMARY

According to an embodiment of the disclosure, a hybrid sensor assembly is configured to be mounted on a vehicle to sense structure borne and airborne noises generated as the vehicle travels over the roads. The sensor assembly includes a housing having a circuit board mounted therein, an accelerometer mounted on the circuit board, a microphone mounted on the circuit board, an acoustic port through the housing and in communication with the microphone, and an acoustic fabric attached to the housing over the port. An acoustic shield covers the acoustic port and substantially deters the entry of fluid and debris into the acoustic port.

To better understand the above-described objectives, characteristics and advantages of the present disclosure, embodiments, with reference to the drawings, are provided for detailed explanations.

### BRIEF DESCRIPTION OF THE DRAWINGS

The present invention is illustrated by way of example, and not limited, in the accompanying figures in which like reference numerals indicate similar elements and in which:

FIG. 1 depicts a perspective view of a hybrid sensor assembly mounted in a wheel well of a vehicle;

FIG. 2 depicts a top perspective view of the hybrid sensor assembly;

FIG. 3 depicts a bottom perspective view of the hybrid sensor assembly;

FIG. 4 depicts an exploded perspective view of the hybrid sensor assembly in accordance with a first embodiment;

FIG. 5 depicts a bottom perspective view of an acoustic shield of the hybrid sensor assembly;

FIG. 6 depicts a side elevation view of the acoustic shield;

FIG. 7 depicts a cross-sectional view along line 7-7 of FIG. 6;

FIG. 8 depicts a cross-sectional view along line 8-8 of FIG. 6;

FIG. 9 depicts a cross-sectional view along line 9-9 of FIG. 3;

FIG. 10 depicts a cross-sectional view along line 10-10 of FIG. 3;

FIG. 11 depicts a cross-sectional view of a second embodiment of the hybrid sensor assembly; and

FIG. 12 depicts a partial cross-sectional view of the hybrid sensor assembly showing lines indicating sound/noise flow and lines indicating water spray.

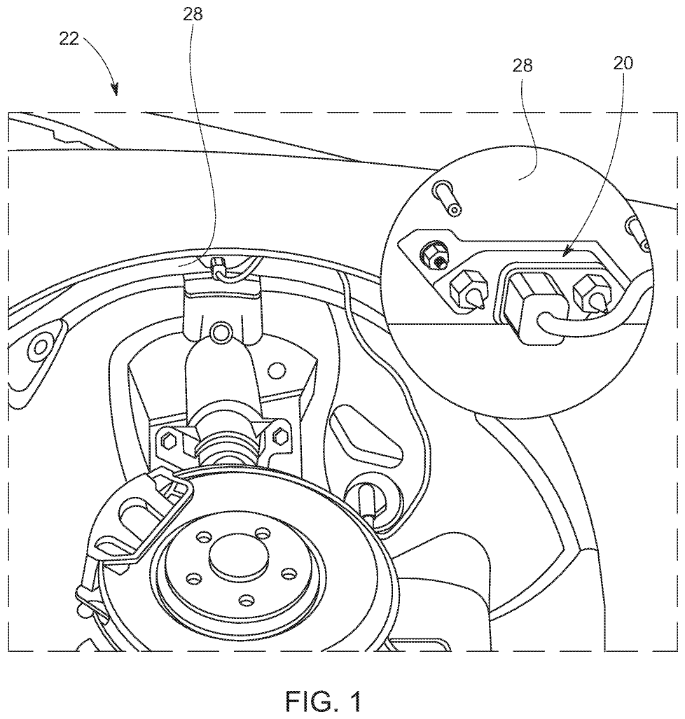

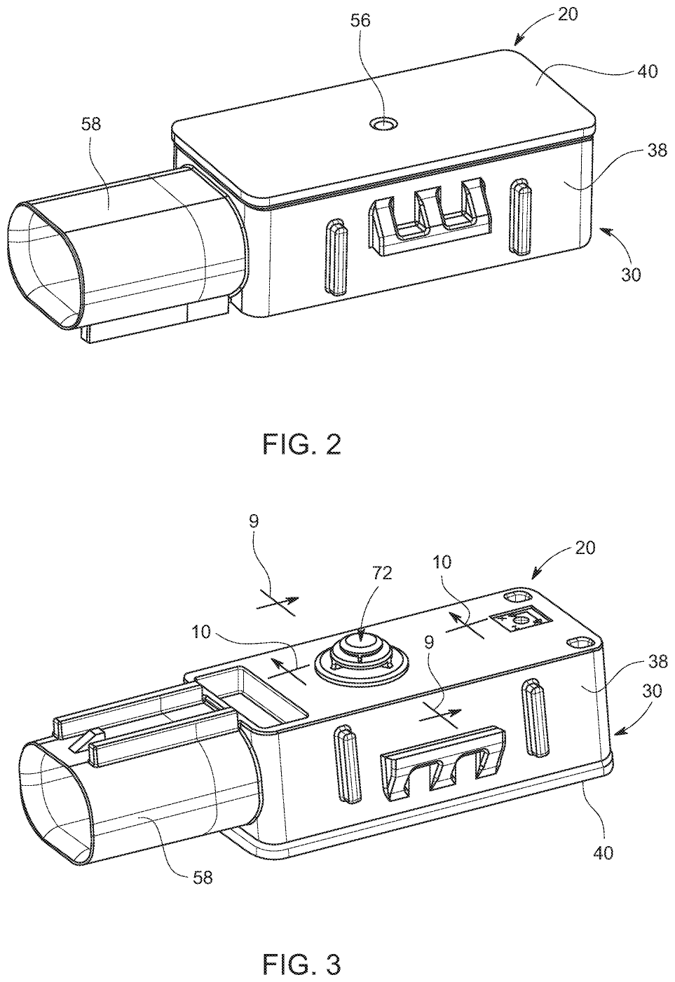

### DETAILED DESCRIPTION

The detailed description that follows describes exemplary embodiments and is not intended to be limited to the expressly disclosed combination(s). Therefore, unless otherwise noted, features disclosed herein may be combined to form additional variations that were not otherwise shown for purposes of brevity.

While the preferred embodiment of the disclosure has been shown and described, it will be apparent to those skilled in the art that changes and modifications may be made therein without departing from the spirit of the disclosure, the scope of which is defined by the appended claims. Like members are designated by like reference characters.

Directional terms such as front, rear, horizontal, vertical and the like are used for ease in explanation, and do not denote a required orientation in use.

The appended figures illustrate an embodiment of the sensor assembly and it is to be understood that the disclosed embodiment is merely exemplary, which may be embodied in various forms. Therefore, specific details disclosed herein are not to be interpreted as limiting, but merely as a basis for the claims and as a representative basis for teaching one skilled in the art to variously employ the present disclosure.

A hybrid sensor assembly 20 is provided for sensing structure borne and airborne noises for a vehicle 22 in the automotive environment for use in an active noise cancellation system. Such structure borne road noises can be due to vibrations entering the vehicle 22 based upon the different road surfaces that are traveled over, and airborne noises can be created from the tire harmonics generated by different air pressure, tread style, material, or tire size. The hybrid sensor assembly 20 combines or pairs a microphone assembly 24, which captures the airborne noise, and an accelerometer 26, which captures the structure borne noise, into one mechanical assembly package which is rigidly mounted on the vehicle 22. The hybrid sensor assembly 20 is mounted on an exterior of the vehicle 22, that is, the hybrid sensor assembly 20 is not mounted in a passenger compartment of the vehicle 22. The hybrid sensor assembly 20 senses the airborne noise and the structure borne noise and this information is transmitted to the active noise cancellation system. The hybrid sensor assembly 20 reduces the space requirements versus using separate sensors and is less costly. The hybrid sensor assembly 20 is mounted to the exterior of the vehicle structure 28 in a location subject to harsh environmental conditions, such as water splash, and may be mounted in the wheel well of the vehicle 22, to an underside of the vehicle 22, or within an engine compartment of the vehicle 22.

The hybrid sensor assembly 20 includes a housing 30 in which a printed circuit board 32 is rigidly mounted, a microphone assembly 34 coupled to the printed circuit board 32, an acoustic shield assembly 36 mounted to the housing 30, and an accelerometer 26 coupled to the printed circuit board 32. The housing 30 is rigidly mounted to the vehicle structure 28 so that structure borne and airborne noises are sensed by the hybrid sensor assembly 20.

The housing 30 has a base 38 and a cover 40 attached thereto which form an internal compartment 42. The base 38 has a lower wall 44, and side walls 46, 48, 50, 52 extending upwardly therefrom. The cover 40 closes the open upper end of the side walls 46, 48, 50, 52. The housing 30 may be formed of plastic, such as polyethylene terephthalate (PET). The housing 30 may be overmolded over the components located therein. The cover 40 is secured to the base 38 to form a fluid tight and debris tight connection. In an embodiment, the cover 40 is laser welded to the base 38. In an embodiment, the lower wall 44 and the cover 40 are rectangular. The lower wall 44 has an acoustic port 54 therethrough. The cover 40 has a mount structure 56 which is used to attach the hybrid sensor assembly 20 to the vehicle structure 28. The mount structure 56 may further include a bracket (not shown) that attaches to the mount structure 56 and to the vehicle structure 28 which is parallel to the printed circuit board 32 or perpendicular to the printed circuit board. While the mount structure 56 is shown on the cover 40, the mount structure may be provided on the base 38. Since the hybrid sensor assembly 20 is mounted to the vehicle structure 28, the physical location for sensing the structural borne and airborne noises creates harsh environmental requirements. These areas see high velocity water spray and/or rocks/stones that are thrown from the tire surface. The housing 30 is designed for such harsh environmental requirements and placement and may have an automotive enclosure IP6K9K rating to resist dust intrusion and water intrusion from high pressure spray that is generated as the vehicle 22 travels over the roads. The housing 30 houses and protects the printed circuit board 32, the microphone assembly 34, and the accelerometer 26 from the environmental requirements. The housing 30 further has an interface connector formed as a socket 58 extending from side wall 46 and pins 60 therein which pass through the side wall 46 and mate with the printed circuit board 32 to form a pluggable interface. A wiring harness (not shown) can be inserted into the socket 58 to mate with the pins 60. While the interface connector is shown extending from side wall 46, the interface connector can extend from the cover 40 or any of the other walls 44, 48, 50, 52 of the base 38.

The microphone assembly 34 senses airborne noise on the exterior of the vehicle 22. The microphone assembly 34 includes a sense element 62 in the form of a chip, an acoustic seal 64 and acoustic fabric 66. The sense element 62 may be a Micro-Electro-Mechanical Systems (MEMS) chip. The acoustic seal 64 has a passageway 68 forming a sound pipe therethrough which extends from an upper end 64a of the acoustic seal 64 to a lower end 64b of the acoustic seal 64. In an embodiment, the passageway 68 is conical. The acoustic seal 64 may be formed of closed cell foam, santoprene, or other suitable known materials. The acoustic port 54 through the base 38 aligns with a lower end 68b of the passageway 68. The acoustic seal 64 isolates the sound path from the acoustic port 54 to the sense element 62 from the remainder of the compartment 42 of the housing 30.

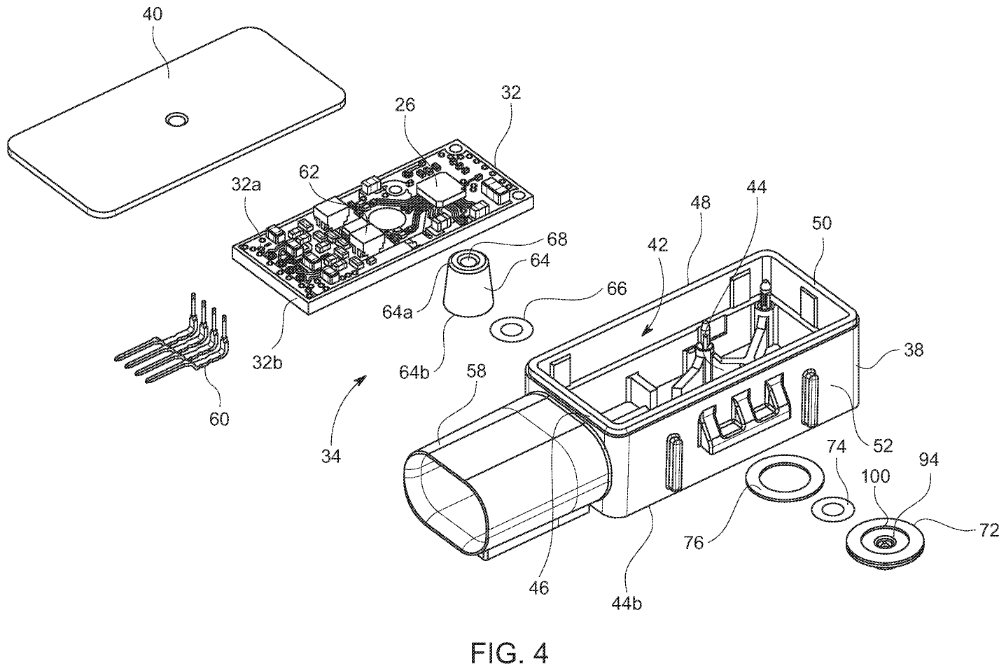

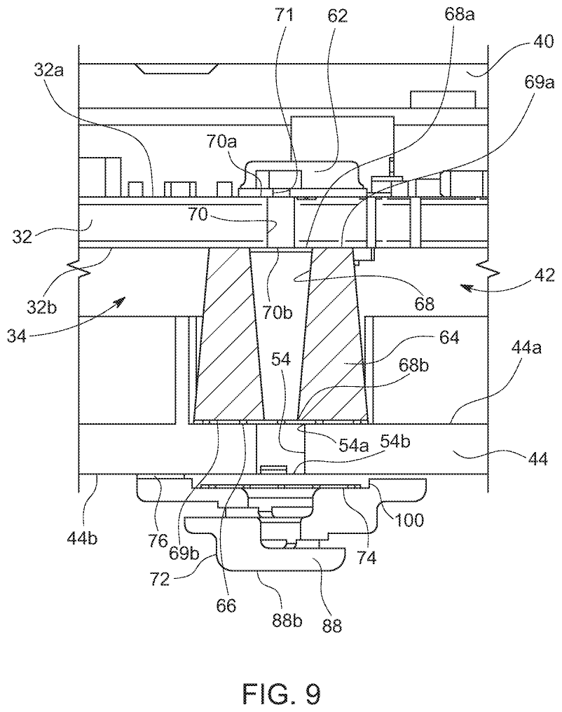

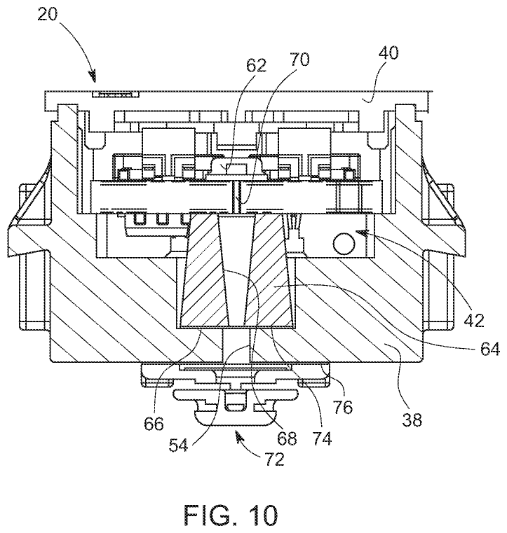

In a first embodiment as shown in FIGS. 4, 9 and 10, the sense element 62 is positioned on an upper side 32a of the printed circuit board 32 and the acoustic seal 64 extends between a lower side 32b of the printed circuit board 32 and the lower wall 44. The acoustic seal 64 may seat within a recess formed in the lower wall 44 or may be surrounded by legs extending upward from the lower wall 44 which form the recess. The printed circuit board 32 has an opening 70 therethrough having a lower end 70b which aligns with an upper end 68a of the passageway 68. The sense element 62 is positioned on the upper side 32a of the printed circuit board 32 above the opening 70 and the passageway 68 and has an opening 71 in the bottom thereof which aligns with an upper end 70a of the opening 70. The acoustic fabric 66 is between the lower end 64b of the acoustic seal 64 and the upper surface 44a of the lower wall 44. The acoustic fabric 66 covers the lower end 68b of the passageway 68 and the upper end 54a of the acoustic port 54.

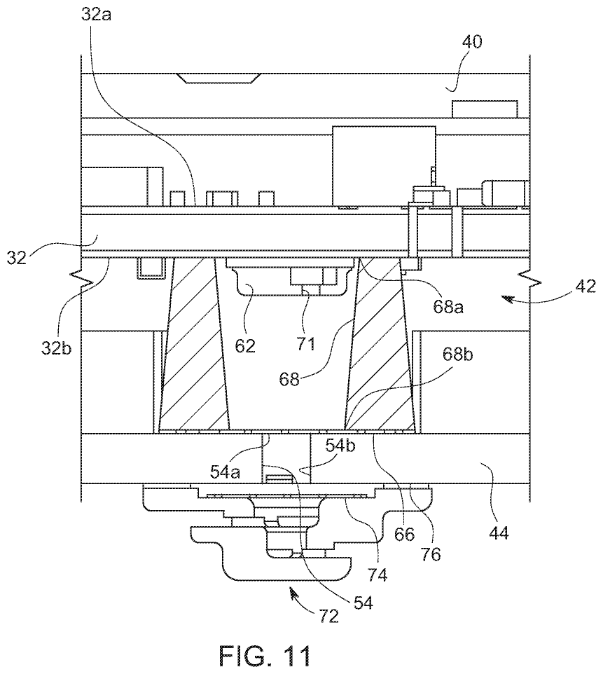

In a second embodiment as shown in FIG. 11, the acoustic seal 64 extends between the lower side 32b of the printed circuit board 32 and the lower wall 44, and the sense element 62 seats within the upper end 68a of the passageway 68 of the acoustic seal 64 and is positioned on the lower side 32b of the printed circuit board 32. The sense element 62 has an opening 71 in the bottom thereof which aligns with the passageway 68. Like the prior embodiment, the acoustic seal 64 may seat within a recess formed in the lower wall 44 or may be surrounded by legs extending upward from the lower wall 44 which form the recess. The acoustic fabric 66 is between the lower end 64b of the acoustic seal 64 and the upper surface 44a of the lower wall 44. The acoustic fabric 66 covers the lower end 68b of the passageway 68 and the upper end 54a of the acoustic port 54.

The acoustic shield assembly 36 includes an acoustic shield 72, an acoustic fabric 74, and a securement 76 for securing the acoustic shield 72 to a lower surface 44b of the lower wall 44 of the base 38.

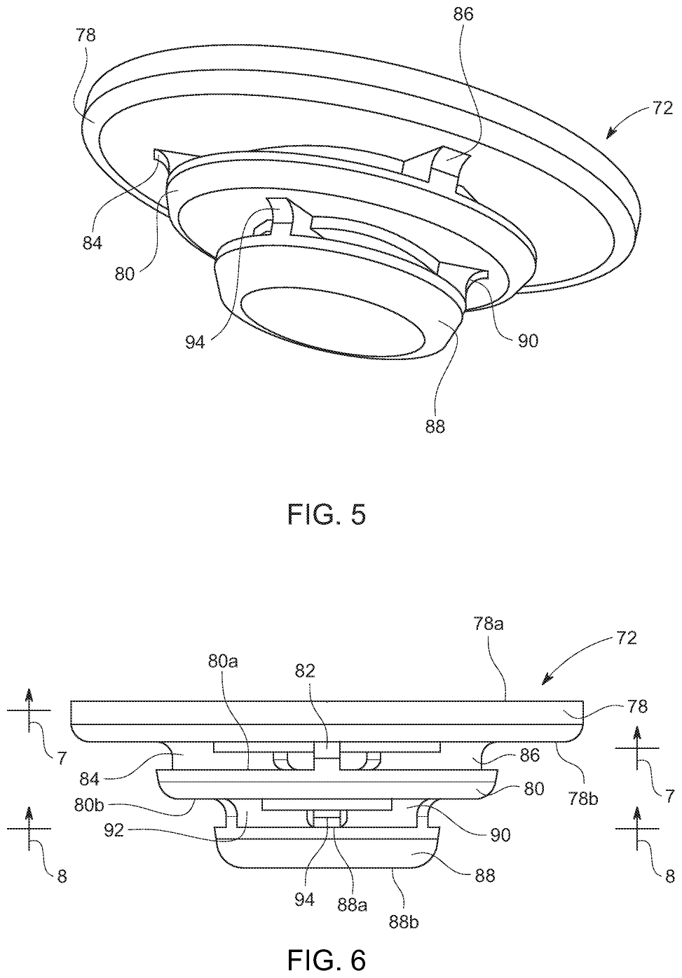

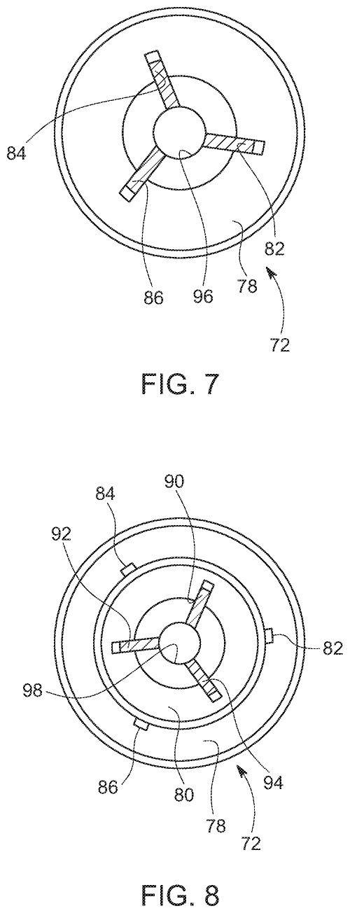

The acoustic shield 72 may be formed of plastic, such as polyethylene terephthalate (PET). As best shown in FIGS. 5-8, the acoustic shield 72 includes an upper, first portion 78 connected to an intermediate, second portion 80 by a plurality of spaced apart legs 82, 84, 86, and a lower, third portion 88 connected to the second portion 80 by a plurality of spaced apart legs 90, 92, 94. The third portion 88 is continuous, that is, the third portion 88 is not interrupted by an opening such that third portion 88 is solid. As shown, the third portion 88 is circular and has planar upper and lower surfaces 88a, 88b. The first portion 78 has an opening 96 therethrough, which may be centrally located. As shown, the first portion 78 is circular and has planar upper and lower surfaces 78a, 78b. The second portion 80 has an opening 98 therethrough, which may be centrally located. The openings 96, 98 may be aligned with each other. As shown, the second portion 80 is circular and has planar upper and lower surfaces 80a, 80b. The first portion 78 has a larger diameter than the second portion 80, and the second portion 80 has a larger diameter than the third portion 88. In an embodiment, the legs 82, 84, 86 are positioned 120 degrees apart from each other, and legs 90, 92, 94 are positioned 120 degrees apart from each other, but are vertically offset from the legs 82, 84, 86. As shown in FIG. 7, the leg 82 is positioned at the zero (0) degree position, leg 84 is positioned at the one-hundred twenty (120) degree position, and leg 86 is positioned at the two-hundred forth (240) degree position. Each leg 82, 84, 86 starts at the opening 96 and extends radially outward. The legs 82, 84, 86 may extend to the outer perimeter of the second portion 80. Passageways are formed between adjacent legs 82, 84, 86 and between the first and second portions 78, 80. As shown in FIG. 8, leg 90 is positioned at the sixty (60) degree position, leg 92 is positioned at the one-hundred eighty (180) degree position, and leg 94 is positioned at the three-hundred (300) degree position. Each leg 90, 92, 94 starts at the opening 98 and extends radially outward. The legs 90, 92, 94 may extend to the outer perimeter of the third portion 88. Passageways are formed between adjacent legs 90, 92, 94 and between the second and third portions 80, 88. As such, the legs 82, 84, 86 are offset from the legs 90, 92, 94. The opening 96 through the first portion 78, the passageways formed by legs 82, 84, 86 and the first and second portions 78, 80, the opening 98 through the second portion 80, and the passageways formed by the legs 90, 92, 94 and the second and third portions 80, 88 are in communication with each other and are in communication with the acoustic port 54 through the housing 30, and form a tortuous path through which sound waves pass through the acoustic shield 72. The tortuous path substantially prevents the passage of water spray which is generated as the vehicle 22 travels over the roads from passing the acoustic shield 72 and into the acoustic port 54. While specific angles are described for the acoustic shield 72, these angles are agnostic to the acoustic shield 72 and do not specify a required orientation relative to an axis of the housing 30. In addition, while three sets of legs 82, 84, 86 and legs 90, 92, 94 are shown, more three sets of legs may be provided between the first and second portion 78, 80 and between the second and third portions 80, 88 so long as the sets of legs are offset from each other. Additionally, while one intermediate portion 80 is shown, more than one intermediate portion can be provided with legs provided therebetween.

The acoustic fabric 74 seats within a recess 100, see FIG. 4, formed in the upper surface 78a of the first portion 78 and is secured thereto. The acoustic fabric 74 covers the upper end of the opening 96. The securement 76 secures the upper surface 78a of the first portion 78 to the lower surface 44b of the lower wall 44 of the housing 30. The securement 76 may be an adhesive.

The acoustic fabrics 66, 74 have oleophobic and hydrophobic properties for repelling water particulates and other chemicals. The acoustic fabrics 66, 74 deter moisture and water intrusion into the compartment 42 and deter dust and debris intrusion into the compartment 42.

The accelerometer 26 senses airborne noise on the exterior of the vehicle 22. The accelerometer 26 is mounted on the upper side 32a of the printed circuit board 32, proximate to the cover 40. Since the accelerometer 26 is mounted in this position within the housing 30, and since the hybrid sensor assembly 20 is rigidly mounted to the vehicle structure 28, structure borne noises are readily transmitted to the accelerometer 26 as a result of the close proximity of the accelerometer 26 to the vehicle structure 28. The accelerometer 26 may be a MEMS accelerometer.

In use, the hybrid sensor assembly 20 is attached to the vehicle structure 28 (sheet metal, frames, body panels, etc.) with the acoustic shield 72 outward from the vehicle structure 28. This outwardly facing direction of the acoustic shield 72 deters impingement on the sound pattern generated during the vehicle travel which could be caused by the vehicle structure 28. The microphone assembly 34 captures airborne noise created by sound pressure waves. The accelerometer 26 is directly adjacent to the vehicle structure 28. Since the vehicle structure 28 and the housing 30 are rigidly connected, a direct link is formed so that structure borne noises are sensed by the accelerometer 26. The accelerometer 26 captures movement, acceleration, and low vibration energy (structure borne) that can be audibly heard within a vehicle passenger compartment along the energy transfer path of the excitations.

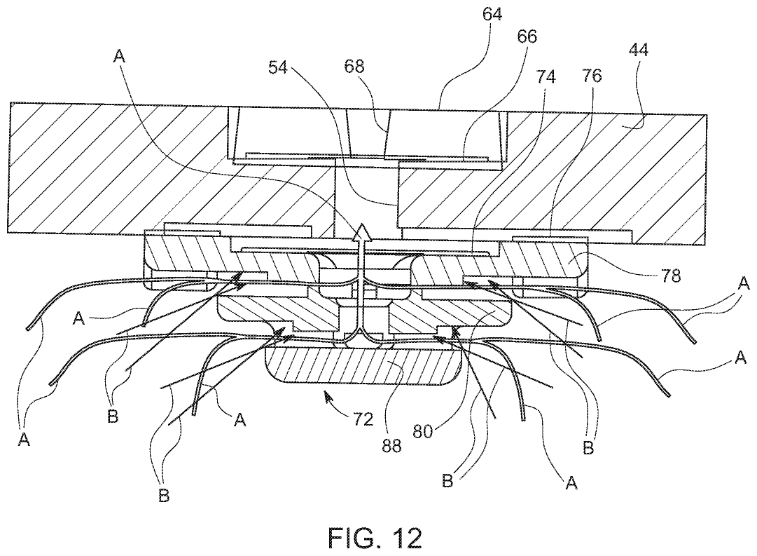

As shown in FIG. 12, the lines A indicate sound/noise flow toward the acoustic port 54 and lines B indicate water spray directed toward the acoustic port 54 during vehicle travel. The flow of the sound pressure wave shown by lines A is minimally impacted by the acoustic shield 72, with a full open range for pressure to reach the acoustic port 54. The acoustic shield 72 creates a tortuous path for outside contaminants (e.g., water, moisture, dust, or debris) to reach the acoustic port 54. The tortuous path reduces the velocity that the outside contaminants travel before reaching the acoustic port 54, reducing the potential for damage to the acoustic fabric 74 that covers the acoustic port 54.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

1. A sensor assembly configured to be mounted on a vehicle comprising:
a housing defining a compartment therein;
a circuit board mounted within the compartment;
an accelerometer mounted on the circuit board;
a microphone mounted on the circuit board;
a port through the housing and in communication with the microphone; and
an acoustic fabric attached to the housing over the port.

2. The sensor assembly of claim 1, wherein the microphone includes a chip mounted on the circuit board and an acoustic seal, the acoustic seal having a passageway extending longitudinally therethrough, the passageway being proximate to the port.

3. The sensor assembly of claim 2, wherein the acoustic seal is formed of one of closed cell foam and santoprene.

4. The sensor assembly of claim 3, wherein the acoustic fabric has oleophobic and hydrophobic properties.

5. The sensor assembly of claim 2, wherein the acoustic seal is on a first side of the circuit board and the chip is on a second side of the circuit board, and an opening is provided through the circuit board between the chip and the acoustic sea1.6. The sensor assembly of claim 5, wherein the accelerometer is on the second side of the circuit board.

7. The sensor assembly of claim 2, wherein the chip and the acoustic seal are on a first side of the circuit board, the chip being positioned within the passageway of the acoustic seal.

8. The sensor assembly of claim 7, wherein the accelerometer is on the second side of the circuit board.

9. The sensor assembly of claim 1, wherein the acoustic fabric has oleophobic and hydrophobic properties.

10. The sensor assembly of claim 1, further comprising an acoustic shield attached to the housing over the acoustic fabric, the acoustic shield having a tortuous pathway therethrough.

11. The sensor assembly of claim 10, wherein
the acoustic shield includes first, second and third portions,
the first portion being continuous,
the second portion having an opening formed therethrough,
the third portion having an opening formed therethrough,
a plurality of first spaced apart legs between the first and second portions thereby forming first passageways between adjacent first legs and the first and second portions,
a plurality of second spaced apart legs between the second and third portions thereby forming second passageways between adjacent second legs and the second and third portions, and
the first passageways, the opening through the second portion, the second passageways, and the opening through the third portion are in communication with each other and in communication with the port through the housing.

12. The sensor assembly of claim 11, wherein the first legs are offset from the second legs.

13. The sensor assembly of claim 12, wherein each first leg starts at the opening through the second portion and extends radially outward, and each second leg starts at the opening through the third portion and extends radially outward.

14. The sensor assembly of claim 1, wherein the circuit board has a first side and a second side, the accelerometer being on the second side of the circuit board, and further including a mount on the housing, the mount being proximate to the second side of the circuit board.

15. The sensor assembly of claim 14, wherein the port through the housing is proximate to the first side of the circuit board, and further comprising an acoustic shield attached to the housing over the acoustic fabric, the acoustic shield having a tortuous pathway therethrough.

16. The sensor assembly of claim 14, in combination with a vehicle, wherein the mount is attached to a wheel well of the vehicle.

17. The sensor assembly of claim 14, in combination with a vehicle, wherein the mount is attached to an underside of the vehicle.

18. An acoustic shield for a sensor assembly comprising:
a first continuous portion;
a second portion having an opening therethrough;
a plurality of first spaced apart legs between the first and second portions thereby forming first passageways between adjacent first legs and the first and second portions;
a third portion having an opening therethrough;
a plurality of second spaced apart legs between the second and third portions thereby forming second passageways between adjacent second legs and the second and third portions; and
the first passageways, the opening through the second portion, the second passageways, and the opening through the third portion are in communication with each other.

19. The acoustic shield of claim 18, wherein the first legs are offset from the second legs, and the openings through the first and second portions are aligned.

20. The sensor assembly of claim 19, wherein each first leg starts at the opening through the second portion and extends radially outward, and each second leg starts at the opening through the third portion and extends radially outward.
